(19) United States
(12) Patent Application Publication
(10) Pub. No.: US 2004/0054888 A1
(43) Pub. Date: Mar. 18, 2004

(54) Method and system of authentication and ownership verification of collectables

(76) Inventor: James S. Chester, Lutz, FL (US)

Correspondence Address: Arthur W. Fisher, III, Suite 316, 5553 West Waters Avenue, Tampa, FL, 33634, US

(21) Appl. No.: 10/246,128

(22) Filed: Sep. 16, 2002

(51) Int. Cl. H04L 9/00

(52) U.S. Cl. 713/155

(57) ABSTRACT

A method and system of authenticating and validating, registering and verifying the authenticity and ownership of items or articles such as memorabilia, collectables and original works of art transferred or exchanged between members of a distribution network including an accrediting authority of the method and system, authorized distributor(s) or supplier(s) of the authenticated items and articles and purchaser(s) or third party transferee(s) of the authentic items and articles comprising the steps of accrediting authorized distributors or suppliers by the accredited authority to sell authentic items or articles, authenticating and validating each item or article with a unique identifier by an authorized distributor or supplier, transferring such items or articles bearing the unique identifier from the authorized distributor or supplier to a third party transferee or purchaser, pre-registering each such item or article with the accrediting authority by the respective authorized distributor, registering each such item or article with the accrediting authority by the transferee or purchaser and verifying the authenticity and ownership of corresponding items or articles by querying the accrediting authority.

### BACKGROUND OF THE INVENTION

1. Field of the Invention

A method and system of authenticating and validating items or articles, registering and verifying the authenticity and ownership of such items or articles.

2. Description of Prior Art

A large and growing market exists for memorabilia such as autographed sports items such as baseballs, footballs, professional sports apparel and the like.

Similarly, the markets for collectables and works of art continue to grow larger.

Due to the substantial value in such collectables counterfeiting of such items and articles has become a major problem. High resolution duplication render detection of counterfeit collectables and works of art extremely difficult. In addition, printing signature machines have made it difficult to determine if a signature or autograph is authentic.

Unfortunately, even with the technology and devices currently known as exemplified below, detecting counterfeit products is difficult and often impossible. Accordingly, there remains a need for a reliable effective method of authenticating and tracking such items.

U.S. Pat. No. 4,882,195 and U.S. Pat. No. 5,194,289 disclose a method for labeling valuable objects such as works of art, negotiable instruments and credit card receipts with identification by applying a person's fingerprint to the object at a predetermined location and exposing the predetermined location to a vaporous agent creating a permanent impression of the fingerprint perceptible only in the presence of UV radiation.

U.S. Pat. No. 5,139,812 shows a high security marking method for protecting valuable objects in the event of theft or forgery by marking such objects with a target chemical capable of subsequent detection. The method comprises the steps of preparing a solution to form a marking pattern, applying the solution to each object of a class of objects to be marked and authenticating the object by detecting solution to reveal the marking.

U.S. Pat. No. 5,267,756 and U.S. Pat. No. 5,380,047 teach an authentication system for memorabilia and other articles by applying a hologram having a unique code to a specific article with tamper-proof adhesive. A certificate of authenticity provided with the article includes the hologram and matching unique code. A master record or list of the unique code and related article is maintained to provide a registration “hotline.” A purchaser can register the article at time of purchase or at any time in the future when the article is sold or otherwise transferred such that authenticity can be verified through the registration hotline.

U.S. Pat. No. 5,306,049 shows a sports memorabilia kit to mark collectable sports item with the thumbprint of the sports figure associated with the item and an authentication card including a duplicate original print together with other identifying indicia to identify the sports figure.

U.S. Pat. No. 5,360,628 and U.S. Pat. No. 5,599,578 relate to a method for labeling an object for verification comprising the application of a mark to a predetermined location on the object to create a permanent impression perceptible to the unaided eye and a permanent impression detectable only by mechanical, electrical, and/or biologic means.

U.S. Pat. No. 5,971,435 teaches a method and system for verifying the authenticity and ownership of an autograph providing a consumer owned article, having the article autographed, issuing a voucher bearing an identifying code, affixing the identifying code to the article, providing a certificate of authenticity bearing a distinct code number different from the identifying code of the article and voucher with a description of the article and identification of the owner and providing a database containing details of the signing and witnessing of the autographing, a record of the codes on the article and the certificate and identification of the owner of the article. The method also provides a record of subsequent transfers of ownership of the article.

U.S. Pat. No. 6,082,774 discloses a method of producing memorabilia articles by affixing one or more integral collectable attractiveness attributes to each selected base article including a facsimile autograph, limited edition markings, a witness-signed authentication statement and notarial confirmation text. The authentication statement or notarial confirmation text may be directly affixed to a base article by imprinting, silk-screen printing, rubber-stamping, photo-offset printing, branding, embossing, handwriting, heat stamping, embroidering, and/or other affixing procedures. The authentication statement or notarial confirmation text may first be created on another body of tangible material such as a piece of paper or cloth that is later affixed to the base article.

### SUMMARY OF THE INVENTION

The present invention relates to a system and method for authenticating and validating items or articles, registering and verifying the ownership and authenticity of such memorabilia transferred between parties through a distribution network of conventional physical transaction distribution channels and electronic commerce including an accrediting authority, authorized distributor(s) or supplier(s) of the authenticated items or articles, third party transferee(s) or purchaser(s) of the authentic items or articles and post sales third party transferee(s) or purchaser(s) of the authentic items or articles to assure the authenticity and ownership through the controlled recorded distribution of the authenticated items or articles.

The system and method of the present invention comprises the steps of accrediting authorized distributors or suppliers, issuing a unique identifier for use with each item or article to be authenticated, authenticating each item or article, validating each item or article with a corresponding unique identifier, selling or transferring ownership of each item or article and issuing a certificate of authenticity to the respective third party transferee or purchaser, pre-registering transfer information of each item or article with the accrediting authority transferred by an authorized distributor or supplier with the accrediting authority, registering the item or article and corresponding owner, verifying the authenticity and ownership of a registered item or article by querying the accrediting authority, transferring an item or article to a subsequent third party transferee or purchaser, issuing a new certificate of authenticity with a new unique identifier to the subsequent third party transferee or purchaser, and registering the transferred item or article and new corresponding owner.

The invention accordingly comprises the features of construction, combination of elements, and arrangement of parts that will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a schematic of the distribution network for implementing the system and method of the present invention.

FIG. 2 is a flow chart depicting the distribution network implementing the system and method of the present invention.

FIG. 3 depicts a workstation used by the various members of the distribution network to implement the system and method of the present invention.

FIG. 4 is a flow chart depicting the sequence of steps implementing the system and method of the present invention.

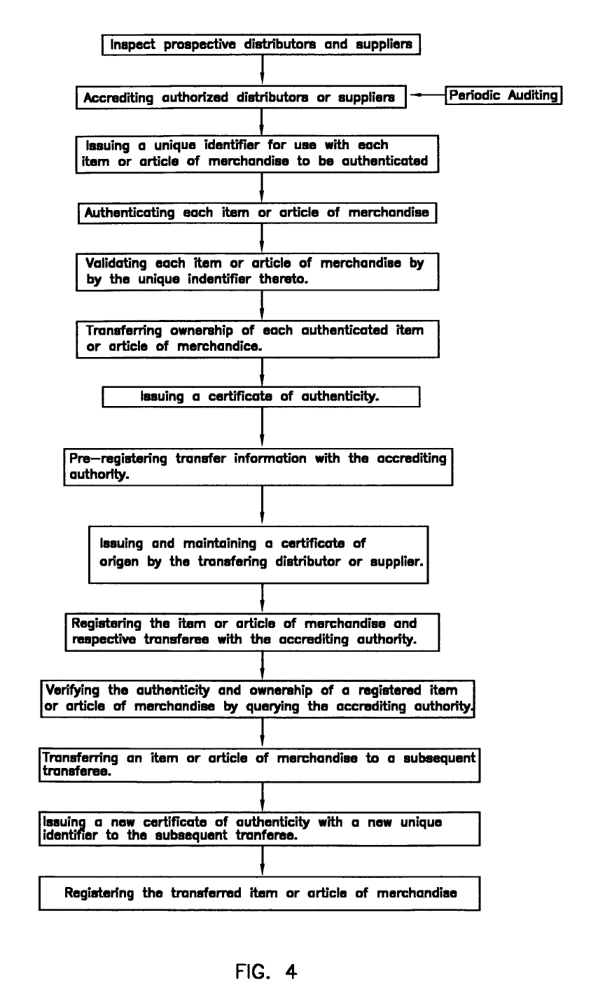

FIG. 5 is a flow chart depicting the sequence of steps of the registration and verification portion of the system and method of the present invention.

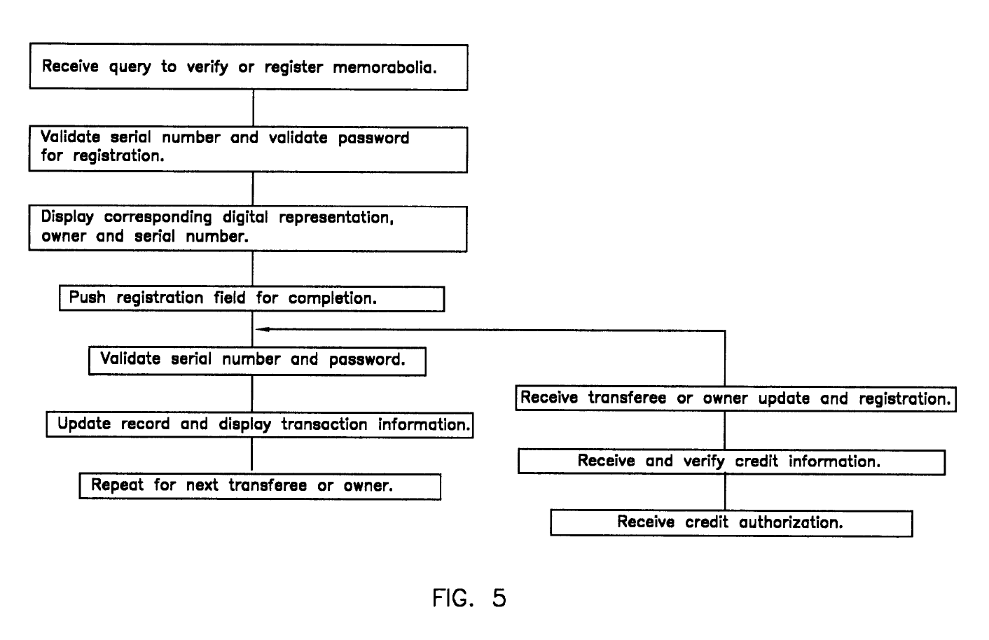

Similar reference characters refer to similar parts throughout the several views of the drawings.

### DESCRIPTION OF THE PREFERRED EMBODIMENT

The present invention relates to a system and method for authenticating and validating items or articles such as memorabilia, collectables or original works of art, registering and verifying the ownership and authenticity of such item or article transferred or exchanged between members of a distribution network of conventional physical transaction distribution channels or electronic commerce including an accrediting authority of the method and system, authorized distributor(s) or supplier(s) of the authenticated item or article, purchaser(s) of the authentic items or articles and post first sale transferee(s) purchaser(s) of the authentic items or articles to assure the authenticity and ownership through a verifiable distribution network.

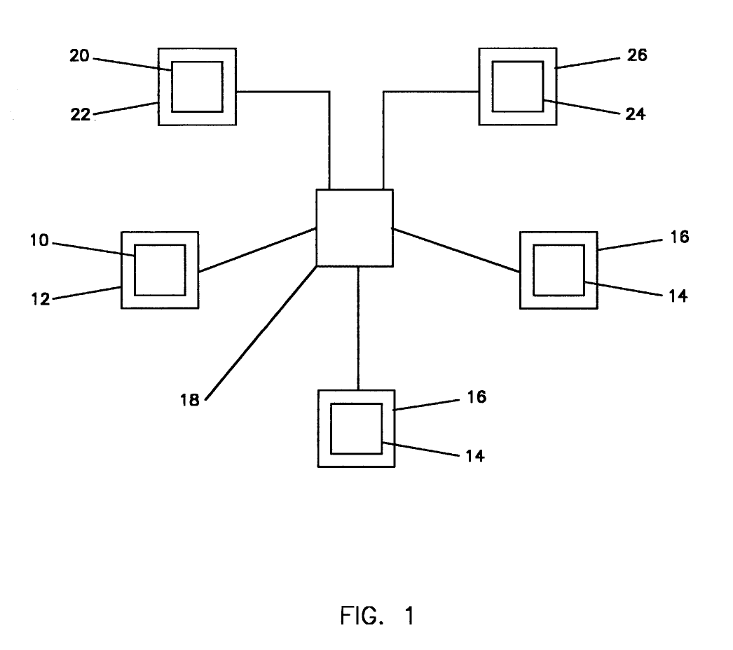

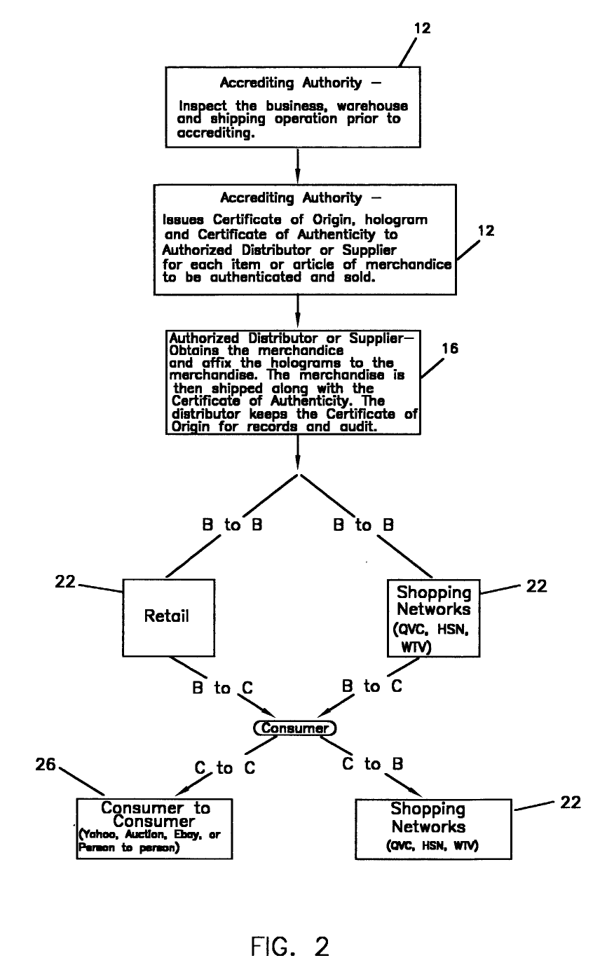

As shown in FIGS. 1 and 2, the system and method of the present invention comprises an accrediting authority computer 10 located at the accrediting authority 12 and an authorized distributor or supplier computer 14 located at one or more corresponding authorized distributors or suppliers each indicated as 16 operatively coupled or linked by a data communication link 18 capable of transferring data and information therebetween. In addition, the accrediting authorizing computer 10 and the authorized distributor or supplier computer 14 are operatively linked to a retailer/network computer 20 located at one or more corresponding retailer/network facilities 22 and a purchaser/transferee/consumer computer 24 located at one or more corresponding purchaser/transferee/consumer 26 by the data communication link 18. The retailer/network computer 20 can also be operatively coupled to the purchaser/transferee/consumer computer 24 by the data communication link 18. Purchaser/transferee/consumer computers 24 may also be operatively coupled to one another by the data communication link 18.

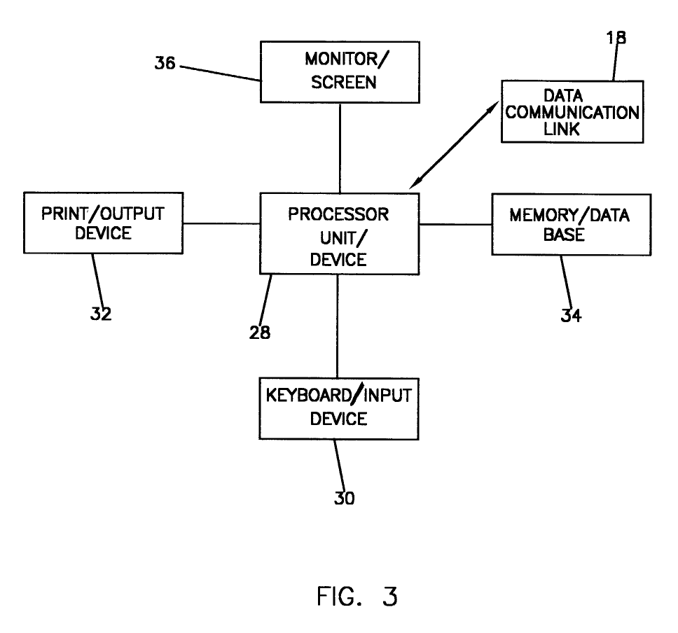

As depicted in FIG. 3, each computer 10, 14, 20 and 24 comprises a processor unit device 28 operatively coupled to a keyboard or input device 30, a printer or output device 32, a memory or data base 34 and a monitor or screen 36. As previously described, the computers 10, 14, 20 and 24 are operatively coupled through the data communication link 18. The data communication link 18 may comprise any suitable state of the art transmitting/receiving system or means.

Each computer 10, 14, 20 and 24 includes information processing and storage capabilities or means to perform the various functions or sequential steps and communications over the data communication link 18 as described hereinafter.

The system and method of the present invention comprises the steps of inspecting prospective distributors or suppliers prior to accreditation by the accrediting authority, accrediting authorized distributors or suppliers by the accrediting authority, issuing a unique identifier including a discrete photopolymer hologram with embedded attributes with encrypted protection and password or personal identification number (PIN) and corresponding documentation including certificate of origin and certificate of authenticity to each authorized distributor or supplier for use with each separate item or article to be authenticated by each authorized distributor or supplier, authenticating each item or article to be sold or transferred by each respective authorized distributor or supplier, validating each item or article by applying the corresponding hologram thereto, selling or transferring ownership of each authenticated item or article and issuing the corresponding certificate of authenticity including a unique alpha-numeric password to the transferee, pre-registering with the accrediting authority transfer information including the name and address by transferring authorized distributor or supplier issuing and maintaining by the transferring distributor or supplier a certificate of origin including the name and address, registering the item or article and respective owner with the accrediting authority upon receiving a request to register properly authenticated item or article by identity match with a password schema, electronic payment, update and promulgation of records and title information, verifying the authenticity and ownership of a registered item or article by querying the accrediting authority, transferring an item or article to a subsequent transferee, issuing a new certificate of authenticity with a new unique password to the subsequent transferee, registering the transferred item or article and subsequent transferee and auditing the facilities, procedures and records of authorized distributors and suppliers by the accrediting authority.

In operation, the members of the trading environment are integrated with the accrediting authorizing of the verification and authentication method and system of the present invention. Only an authorized distributor or supplier can acquire, affix, record and provide the complex hologram, unique identifier and unique password for any specific authenticated item or article. Only the authorized distributor or supplier selling or transferring the specific authenticated item or article retains a corresponding certificate of origin for audit and record creation purposes. The location, identification, ownership and registration of authenticated items or articles is maintained by the accrediting authority.

Authorized distributor(s) or supplier(s) 16 access the trading environment over the data communication link 18. The accrediting authority 12 provides a secure distributor or supplier authentication and access environment to an secure database through any suitable state of the art computer and network display system. Authorized distributor(s) or supplier(s) 16 enter the accrediting authority assigned user information and password authentication credentials to open and enable a secure pre-registration and management session. Database integrity and security extends to all field components with limited modification or alteration privileges. The accrediting authority 12 assigns the appropriate fields and particular identifier information for type, item, and requisite autograph assignee.

Verification and/or title transferee information is also accessed through the trading environment over the data communication link 18. The accrediting authority 12 provides a secure search field for title search and ownership verification. The unique serial number and categorization is singularly assigned once to each item or article to complete the electronic birthmark in association with the physical birthmark affixed and recorded by the authorized distributor or supplier 16. Once the unique serial number is entered into the search field, the trusted trading environment queries record files for the correct information and presents the current owner by name and a static digital image representation of the particular item or article.

Registration of the title transferee is accomplished through a separate field within the trading environment. The prospective registrant or transferee 26 accesses the secure interface over the data communication link 18. The registration field requires the prospective registrant to enter both a serial number and unique password to gain access to the secure registration environment. The trading environment then makes a request of the master database file to verify serial number and matching unique password information. Incorrect information immediately halts attempted access and returns the prospective registrant to the initial field. Once authenticated, the prospective registrant is required to enter location and contact information in concert with electronic payment credentials for record registration and maintenance. Once payment credentials are verified and debited over an secure authentication provider, title transference is accomplished over an immediate update of the master database with associated electronic serial number and title owner. The method and system of the present invention is embodied in a secure delivery environment including one or more servers. These servers include multiple computing and storage devices on which reside multiple applications for the protection, interrogation, query, cataloging, recording, recall, display, and modification of trading environment information. These servers also include secure access for electronic funds verification and collection. These servers are physically and electronically protected from fraudulent access and interrogation over complex location and access schemas enabled through the switching and firewall environments. Furthermore, the master databases and financial information are maintained on a separate network completely isolated from the public Internet.

If improper or incorrect information or data is entered or not verified by the master database, the requestor is notified to return to the previous screen for correct information entry over a secure back path. Alternative paths do not exist to allow any access to the master database and financial files. Physical and electronic separation is maintained for all databases and queries.

All transactions and queries are monitored and protected by a combination of physical and electronic methods to ensure environment integrity. While linkages may be made to the environments, no direct database access or permanent record modifications can be made. Network, password, firewall, and database encryption techniques are used in combination to ensure environment integrity.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. A method and system of authenticating and validating, registering and verifying the authenticity and ownership of items or articles transferred or exchanged between members of a distribution network including an accrediting authority of the method and system, authorized distributor(s) or supplier(s) of the authenticated item or article and purchaser(s) or third party transferee of the authentic items or articles, comprising the steps of accrediting authorized distributors or suppliers by the accredited authority to sell authentic item or article, authenticating and validating each item or article with a unique identifier by an authorized distributor or supplier, transferring such items or articles bearing the unique identifier from the authorized distributor or supplier to a transferee, registering each such item or article with the accrediting authority by each transferee upon receiving a request.

2. The method and system of claim 1 wherein prospective distributors or suppliers are inspected prior to accreditation by the accrediting authority.

3. The method and system of claim 2 wherein there is periodic auditing of authorized distributors and suppliers by the accrediting authority.

4. The method and system of claim 1 wherein each item or article is pre-registered with the accrediting authority by the transferring authorized distributor or supplier.

5. The method and system of claim 1 wherein a unique identifier including a discrete hologram and password is issued for each item or article.

6. The method and system of claim 1 wherein a certificate of authenticity is issued for each item or article.

7. The method and system of claim 1 wherein a certificate of origin is issued and maintained by the transferring distributor or supplier for each item or article.

8. The method and system of claim 1 wherein a request to register properly authenticated item or article and verification of identity are matched with a password schema, electronic payment, updated and promulgation of records and title information to each transferee.

9. The method and system of claim 1 wherein the authenticity and ownership of a registered item or article may be verified by querying the accrediting authority.

10. The method and system of claim 9 wherein an item or article is transferred to a subsequent transferee.

11. The method and system of claim 10 wherein a new certificate of authenticity is issued to the subsequent transferee with a new unique identifier for each item or article.

12. The method and system of claim 11 wherein the item or article is registered and transferred to the subsequent transferee.

13. The method and system of claim 4 wherein a request to register properly authenticated item or article and verification of identity are matched with an encryption schema, electronic payment, updated and promulgation of records and title information to each transferee.

14. The method and system of claim 13 wherein a certificate of authenticity is issued for each item or article.

15. The method and system of claim 14 wherein a certificate of origin is issued and maintained by the transferring distributor or supplier for each item or article.

16. The method and system of claim 14 wherein the authenticity and ownership of a registered item or article may be verified by querying the accrediting authority.

17. The method and system of claim 16 wherein an item or article is transferred to a subsequent transferee and the item or article is registered and transferred to the subsequent transferee.

18. The method and system of claim 17 wherein a new certificate of authenticity is issued to the subsequent transferee with a new unique identifier for each item or article.

19. The method and system of claim 5 wherein a certificate of authenticity is issued for each item or article.

20. The method and system of claim 19 wherein each item or article is pre-registered with the accrediting authority by the transferring authorized distributor or supplier.

21. The method and system of claim 19 wherein a certificate of origin is issued and maintained by the transferring distributor or supplier.

22. The method and system of claim 20 wherein the authenticity and ownership of a registered item or article may be verified by querying the accrediting authority.

23. The method and system of claim 20 wherein an item or article is transferred to a subsequent transferee and the item or article is registered and transferred to the subsequent transferee.

24. The method and system of claim 23 wherein a new certificate of authenticity is issued to the subsequent transferee with a new unique identifier for each item or article.

25. The method and system of claim 1 wherein registration of title transfer is accomplished through a separate field within the trading environment, the prospective registrant or transferee accesses the secure interface, the registration field requires the prospective registrant to enter both a serial number and unique password to gain access to the secure registration environment, the trading environment then makes a request of the master database file to verifying serial number and matching password information, once authenticated, the prospective registrant is required to enter location and contact information in concert with electronic payment credentials for record registration and maintenance, once payment credentials are verified and debited over a secure authentication provider, title transfer is accomplished on immediate update of the master database with associated electronic serial number and title owner.
